(19) United States
(12) Patent Application Publication
(10) Pub. No.: US 2021/0124544 A1
(43) Pub. Date: Apr. 29, 2021

(54) Mobile Display Device with Multiple Display Panels and Segregated System Components

(71) Applicants: David W. Burns, San Jose, CA (US); Debra Brubaker Burns, San Jose, CA (US)

(72) Inventors: David W. Burns, San Jose, CA (US); Debra Brubaker Burns, San Jose, CA (US)

(21) Appl. No.: 17/083,274

(22) Filed: Oct. 28, 2020

Related U.S. Application Data
(60) Provisional application No. 62/927,045, filed on Oct. 28, 2019.

(51) Int. Cl. G06F 3/14; G06F 1/16

(52) U.S. Cl. CPC G06F 3/1446; G06F 3/0488; G06F 1/1641; G06F 1/1681

(57) ABSTRACT

A mobile display device may include a first display panel with a display screen having a viewing surface and a second display panel with a display screen having a viewing surface. The display panels may be coupled with a multi-position hinge. A first operating system may be coupled to the first display panel and a second operating system may be coupled to the second display panel. The first operating system may operate independently of the second operating system and the second operating system may operate independently of the first operating system.

### CROSS-REFERENCE TO RELATED APPLICATIONS

This patent application claims priority to U.S. Provisional Patent Application No. 62/926,930 filed on Oct. 28, 2019 entitled “Mobile Display Device with Multiple Display Panels” and U.S. Provisional Patent Application No. 62/927,045 filed on Oct. 28, 2019 entitled “Mobile Display Device with Dual Display Panels and Segregated System Components”, each hereby incorporated by reference in their entirety for all purposes.

### FIELD OF THE INVENTION

This patent disclosure relates generally to the field of wireless mobile devices and more specifically to wireless devices with multiple display panels.

### BACKGROUND OF THE INVENTION

Current wireless multimedia devices such as cell phones and tablet computers are generally configured with a single display panel and touchscreen that a user may view and interact with. While some users may carry two different cell phones on their person throughout the day to accommodate different work requirements and personal needs, others may use the same phone for both work and personal use, which can sometimes compromise workplace confidentiality concerns on one hand and personal data on the other.

### BRIEF SUMMARY OF THE INVENTION

A mobile display device may include a first display panel having a display screen with a viewing surface and a second display panel having a second display screen with a second viewing surface. The display panels may be coupled with a multi-position hinge. A first operating system may be coupled to the first display panel and a second operating system that is separate from the first operating system may be coupled to the second display panel. The first and second operating systems may operate independently of each other. The first operating system may provide display information to the first display screen and the second operating system may provide display information to the second display screen. In some implementations, the first operating system may be configured to not provide display information to the second display screen and the second operating system may be configured to not provide display information to the first display screen.

Display information from the first operating system may be provided to the first display screen and display information from the second operating system may be provided to the second display screen when the first display panel and the second display panel are configured in a closed configuration, a paperback configuration, a tablet configuration, or a back-to-back configuration. The first display panel may be enclosed within a first enclosure and the second display panel may be enclosed within a second enclosure. The multi-position hinge may mechanically couple the first enclosure to the second enclosure.

The mobile display device may include a first battery module electrically coupled to the first operating system and a second battery module electrically coupled to the second operating system. The first battery module may be enclosed within the first enclosure and the second battery module may be enclosed within the second enclosure.

The mobile display device may include a first communication module coupled to the first operating system and a second communication module coupled to the second operating system. The first communication module may be enclosed within the first enclosure and the second communication module may be enclosed within the second enclosure. The first communication module may be configured to send a wireless signal to the second communication module to effect a change on the second display panel when a software application or a software-generated window running on the first operating system detects a touch of a user on the first display panel.

The mobile display device may include a first sensor module coupled to the first operating system and a second sensor module coupled to the second operating system. The first sensor module may be enclosed within the first enclosure and the second sensor module may be enclosed within the second enclosure. The first sensor module and the second sensor module may include one or more orientation sensors, motion detectors, ambient light sensors, eye-gazing detection systems, user identification systems, in-display fingerprint sensors, through-display fingerprint sensors, or finger detection sensors.

A method of operating a mobile display device may include the steps of determining a configuration of the mobile display device having a first display panel enclosed within a first enclosure and a second display panel enclosed within a second enclosure that are mechanically coupled with a multi-position hinge; determining an orientation of the mobile display device; determining whether the mobile display device is to be operated in a first task mode, a second task mode, or both a first task mode and a second task mode; and providing display information to the first display panel, the second display panel, or both the first display panel and the second display panel based on the configuration, the orientation, and the task mode.

The configuration of the mobile display device may be a closed configuration, a paperback configuration, a tablet configuration, or a back-to-back configuration. The second display panel may include a touchscreen so that when configured in the back-to-back configuration, a software application or a software-generated window running in the mobile display device may be configured to allow a touch of a user on the backside touchscreen to activate a function on the first, front-side display panel. The orientation of the display information provided to the display screens of the mobile display device may be a portrait orientation, a landscape orientation, a first task orientation, or a second task orientation. The first task mode may correspond to a work usage mode and the second task mode may correspond to a personal usage mode. The display information to the first display panel may be provided by a first operating system enclosed within the first enclosure and the display information to the second display panel may he provided by a second operating system enclosed within the second enclosure. The method may include updating the display information to the first display panel or the second display panel when the task mode is changed. The first operating system may be configured to send a wireless signal to the second operating system to effect a change on the second display panel when a software application or a software-generated window running on the first operating system detects a touch of a user on the first display panel.

A system for operating a mobile display device may include a first display panel enclosed within a first enclosure and a second display panel enclosed within a second enclosure. The first enclosure and the second enclosure may be mechanically coupled with a multi-position hinge. The system may include a first operating system contained within the first enclosure that is coupled to the first display panel and a second operating system contained within the second enclosure that is coupled to the second display panel. The first operating system and the second operating system may be configured to allow determining a configuration of the mobile display device; determining an orientation of the mobile display device; determining whether the mobile display device is to he operated in a first task mode, a second task mode, or both a first task mode and a second task mode; and providing display information to the first display panel, the second display panel, or both the first display panel and the second display panel based on the configuration, the orientation, and the task mode.

The first operating system and the second operating system may be configured to allow updating the display information to the first display panel or the second display panel when the task mode is changed.

Computer-readable medium for operating a mobile display device having multiple display panels may include computer-readable instructions for determining a configuration of the mobile display device. with a first operating system and/or a second operating system; determining an orientation of the mobile display device with the first operating system and/or the second operating system; determining whether the mobile display device is to be operated in a first task mode, a second task mode, or both a first task mode and a second task mode; and providing display information to the first display panel from the first operating system and/or providing display information to the second display panel based on the configuration, the orientation, and the task mode. The computer-readable medium may be configured to allow updating the display information to the first display panel or the second display panel when the task mode is changed.

### BRIEF DESCRIPTION OF THE DRAWINGS

FIG. 1 shows a block diagram of a system for operating a mobile display device having multiple display panels and segregated system components.

FIG. 2 shows a mobile display device with multiple display panels in various configurations including a closed configuration, a paperback configuration, a tablet configuration and a back-to-back configuration.

FIG. 3 shows an exploded view of a mobile display device with two display panels, segregated system components, and a multi-position hinge coupling the first display panel to the second display panel.

FIG. 4A through FIG. 4D illustrate various configurations of a mobile display device including a closed configuration, a paperback configuration, a tablet configuration and a back-to-back configuration.

FIG. 5 illustrates a mobile display device in a paperback configuration with one display panel operating in a first task mode and second display panel operating in a second task mode.

FIG. 6 illustrates a mobile display device in a tablet configuration with one display panel operating in a first task mode and the second display panel operating in a second task mode, each display operating in either a portrait mode or a landscape mode.

FIG. 7A and FIG. 7B illustrate a mobile display device in a back-to-back configuration with one display panel operating in a first task mode in either a portrait mode or a landscape mode and the second display panel operating in a second task mode in either a portrait mode or a landscape mode.

FIG. 8 illustrates various configurations of a mobile display device having a quartet of display panels.

FIG. 9 illustrates a side view of a multi-position hinge coupling two display panels.

FIG. 10 shows a perspective view of one implementation of a multi-position hinge for a mobile display device having multiple display panels.

FIG. 11 shows a block diagram illustrating a method of operating a mobile display device having multiple display panels.

FIG. 12 illustrates computer-readable medium for operating a mobile display device having multiple display panels and segregated operating systems.

### DETAILED DESCRIPTION OF THE INVENTION

The present invention allows a single device to provide segregated services to an individual with one set of services and hardware associated with, for example, work life and another set of services and hardware associated with, for example, personal life. Mobile display devices with multiple display panels and segregated system components provide clear physical firewalls between the two sets of services yet provide the convenience of a single device to the user. The mobile display devices described herein have applications for online and standalone gaming, e-book readers, ecommerce, social media, distance learning, notebook computers, video conferencing, and conventional texting and telephonic calls.

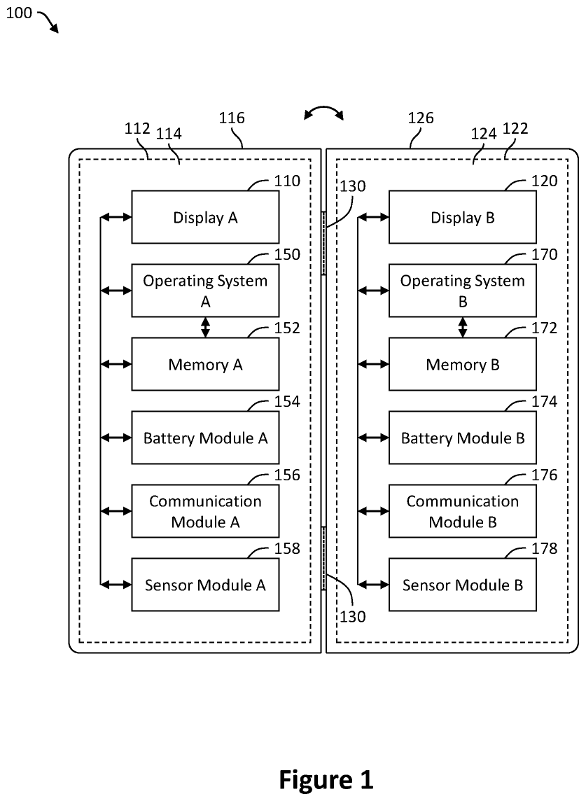

FIG. 1 shows a block diagram of a system for operating a mobile display device 100 having multiple display panels 110, 120 and segregated system components. Mobile display device 100 may include one or more display panels enclosed within an enclosure 116 and one or more display panels enclosed within a second enclosure 126. Mobile display device 100 may include a display panel 110 having a display screen 112 with a viewing surface 114 housed in enclosure 116. Mobile display device 100 may include a second display panel 120 having a display screen 122 with a viewing surface 124 housed in enclosure 126. Enclosures 116, 126 with display panels 110, 120 may be mechanically coupled with a multi-position hinge 130.

The system may include an operating system 150 coupled to display panel 110 and a second operating system 170 coupled to display panel 120. Operating system 150 may be contained entirely within enclosure 116 while operating system 170 may be contained entirely within enclosure 126. Operating system 150 may operate independently of operating system 170 and operating system 170 may operate independently of operating system 150.

Operating systems 150, 170 may include one or more local or remote processors and local or external memory 152, 172. Data, power and control signals may be conveyed via local electrical buses. Operating system 150 may provide display information to display screen 112 and operating system 170 may provide display information to display screen 122. In some implementations, operating system 150 may be configured to not provide display information to display screen 122 and operating system 170 may be configured to not provide display information to display screen 112. Operating systems 150, 170 may be configured to allow determining a configuration of mobile display device 100; determining an orientation of mobile display device 100; determining whether mobile display device 100 is to be operated in a first task mode, a second task mode, or both task modes; and providing display information to one or more of display panels 110, 120 based on the configuration, the orientation, and the task mode.

One or more processors within operating system 150 and/or dedicated controllers may provide display information to display panel 110 and other processors within operating system 170 and/or dedicated controllers may provide display information to display panel 120. Display information from operating system 150 may be provided to display screen 112 and display information from operating system 170 may be provided to display screen 122 when display panel 110 and display panel 120 are configured in a closed configuration, a paperback configuration, a tablet configuration, or a back-to-back configuration. Display controllers interfacing with a touchscreen may be configured to detect finger touches and swipes of a user on display panels 110, 120 accordingly.

The processors and controllers of operating systems 150, 170 may be configured to allow detecting an orientation of mobile display device 100 and/or a hinge angle of multi-position hinge 130, generating display information for display panels 110, 120, and providing display information to one or both of display panels 110, 120 based on the orientation of mobile display device 100 and the hinge angle when mobile display device 100 is positioned in a closed, paperback, tablet, or back-to-back configuration. Operating systems 150, 170 may be configured to allow updating display information to one or more display panels when the task mode or the device configuration is changed.

Mobile display device 100 may include one or more battery modules 154 electrically coupled to operating system 150 and one or more battery modules 174 electrically coupled to operating system 170. Battery modules 154 may be enclosed within enclosure 116 and other battery modules 174 may be enclosed within enclosure 126. Battery modules 154, 174 may provide electrical power to allow portable and mobile use of mobile display device 100.

Mobile display device 100 may include a communication module 156 coupled to operating system 150 and a second communication module 176 coupled to operating system 170. Communication module 156 may be enclosed within enclosure 116 and communication module 176 may be enclosed within enclosure 126. Communication modules 156, 176 may transmit and receive signals via one or more wired or wireless communication links. Communication module 156 may be configured to send a signal via one or more wireless communication links to communication module 176 to effect a change on display panel 120 when a software application or a software-generated window running on operating system 150 detects a touch of a user on display panel 110.

Mobile display device 100 may include a sensor module 158 coupled to operating system 150 and a second sensor module 178 coupled to operating system 170. Sensor module 158 may be enclosed within enclosure 116 and sensor module 178 may be enclosed within enclosure 126. Sensor module 158 and sensor module 178 may include one or more orientation sensors, motion detectors, ambient light sensors, eye-gazing detection systems, user identification systems, in-display fingerprint sensors, through-display fingerprint sensors, or finger detection sensors. Fingerprint and finger detection sensors may be capacitive, optical or ultrasonic. Sensor modules 158, 178 may include one or more hinge-position detectors to provide one or more hinge-angle signals and/or one or more orientation sensors to provide one or more orientation sensor signals.

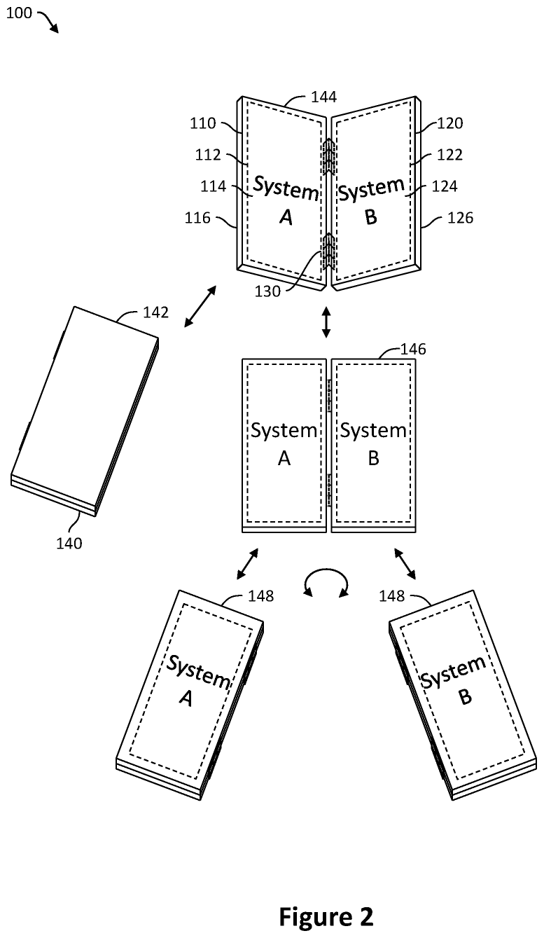

FIG. 2 shows mobile display device 100 with multiple display panels 110, 120 in various configurations 140 including a closed configuration 142, a paperback configuration 144, a tablet configuration 146, and a back-to-back configuration 148. Display panel 110 with display screen 112 and viewing surface 114 may be positioned in enclosure 116. Display panel 120 with display screen 122 and viewing surface 124 may be positioned in enclosure 126. One or more multi-position hinges 130 may mechanically couple enclosure 116 with display panel 110 to enclosure 126 with display panel 120.

Mobile display device 100 may be configured in closed configuration 142 where viewing surface 114 of display screen 112 is positioned against viewing surface 124 of display screen 122 with a closed hinge angle of approximately zero degrees. Closed configuration 142 may provide physical and mechanical protection of display screens 112, 122 while mobile display device 100 is not in use. Alternatively, mobile display device 100 may be configured in paperback configuration 144 where viewing surface 114 of display screen 112 and viewing surface 124 of display screen 122 are positioned at a paperback hinge angle so that display screens 112, 122 may be simultaneously viewable by a user of mobile display device 100. Paperback configuration 144 may have a paperback hinge angle between about 60 degrees and 180 degrees to allow a user to view or read from either viewing surface 114 or viewing surface 124 in a paperback viewing mode, allowing comfortable, compact reading from either display screen 112, 122 with an increased level of privacy and intimacy compared to a single-display device.

Alternatively, mobile display device 100 may be configured in tablet configuration 146 where viewing surface 114 of display screen 112 and viewing surface 124 of display screen 122 are positioned at a tablet hinge angle such that viewing surface 114 of display screen 112 and viewing surface 124 of display screen 122 lie substantially in a common viewing plane. Tablet configuration 146 may have a tablet hinge angle of nominally 180 degrees to allow a user to view either viewing surface 114 or viewing surface 124 or to simultaneously view both viewing surfaces 114, 124. In some implementations, mobile display device 100 in tablet configuration 146 may be comfortably placed on a flat surface for writing on or otherwise interacting with display screens 112, 122.

Alternatively, mobile display device 100 may be configured in back-to-back configuration 148 where viewing surfaces 114, 124 of display screens 112, 122 face opposite directions. Back-to-back configuration 148 may have a back-to-back hinge angle of nominally 360 degrees to allow a user to view either display screen 112 or display screen 122 much as in a single-screen mobile device. While a user of mobile display device 100 in back-to-back configuration 148 may normally view and interact with only one viewing surface 114, 124 at a time, back-to-back configuration 148 allows different software applications and viewable materials to run simultaneously on either side of mobile display device 100, allowing the user to interact with one side while occasionally rotating or flipping mobile display device 100 to view and interact with the opposite side. In some implementations, one or more of the display panels 110, 120 may include a touchscreen. A software application or a software-generated window running in mobile display device 100 may be configured to allow a touch of a user on the touchscreen of one display panel to effect a change on the other display panel. For example, when mobile display device 100 is configured in back-to-back configuration 148, a user such as a gamer may press, swipe or otherwise touch a backside touchscreen to activate a function on the front-side display so that the finger touching the backside touchscreen does not occlude the user's view of the front-side display. The software application or window may be configured to display a specific icon or other graphic on either or both the backside and front-side displays to correlate a backside touch with a front-side function.

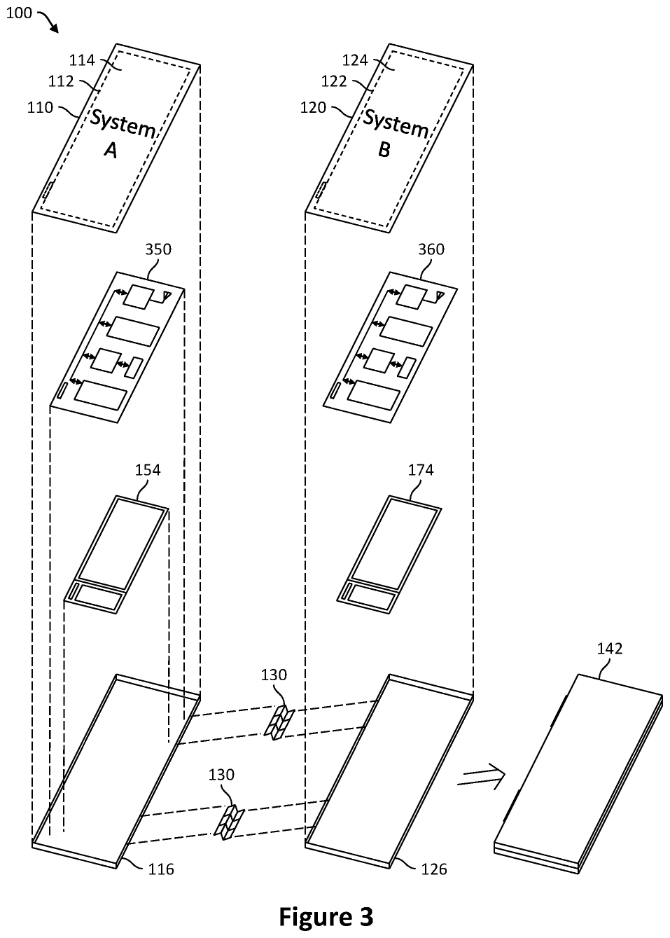

FIG. 3 shows an exploded view of mobile display device 100 with display panels 110, 120, segregated system components, and multi-position hinge 130 coupling display panel 110 to display panel 120. Display panel 110 with display screen 112 and viewing surface 114 may be housed in enclosure 116 along with a main PCB (printed circuit board) 350 including various processors, memory, components, switches and connectors. Enclosure 116 may include one or more battery modules 154. Display panel 120 with display screen 122 and viewing surface 124 may be housed in enclosure 126 along with a second main PCB 360 with other processors, memory, components, switches and connectors. Enclosure 126 may include one or more battery modules 174. Enclosure 116 may be coupled to enclosure 126 with one or more multi-position hinges 130. With assembly complete, mobile display device 100 may be configured in closed configuration 142 for shipping, storage and usage. Display panels 110, 120 may include one or more LED displays, OLED displays, AMOLED displays, backlit displays, front-lit displays, touchscreens, in-display fingerprint sensors, through-display fingerprint sensors, or other display devices. The display panels and display screens described herein are substantially rigid and separable. One or more multi-position hinges 130 may physically separate display panels 110, 120 to allow viewing surfaces 114, 124 of display screens 112, 122 to be continuously unfolded from a closed position to a fully open flat position and further to a completely back-to-back configuration.

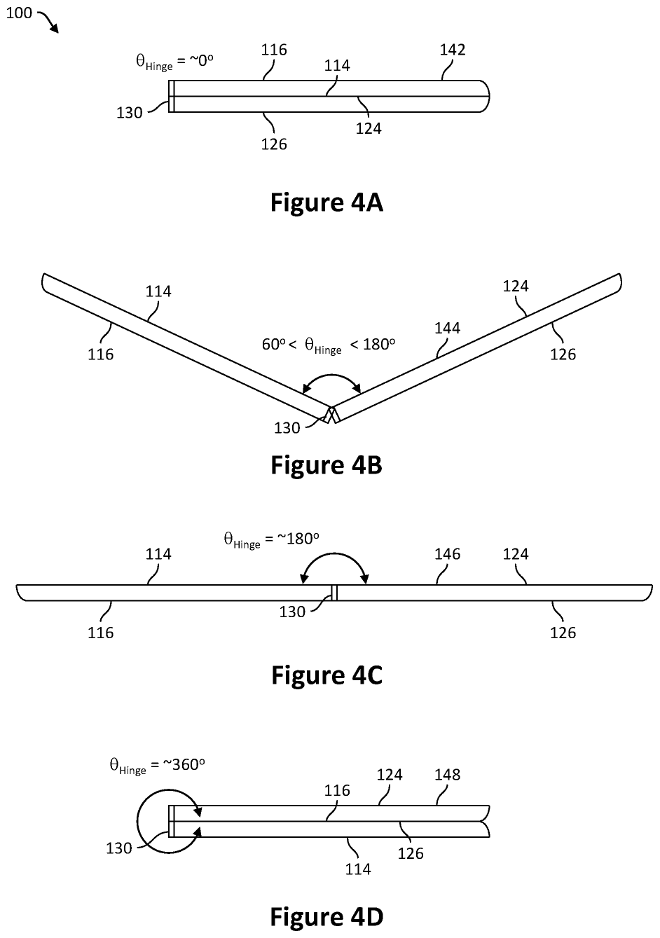

FIG. 4A through FIG. 4D illustrate various configurations of mobile display device 100 including closed configuration 142, paperback configuration 144, tablet configuration 146 and back-to-back configuration 148. FIG. 4A shows a side view of mobile display device 100 in closed configuration 142, with viewing surface 114 of display screen 112 within enclosure 116 positioned against viewing surface 124 of display screen 122 within enclosure 126. Multi-position hinge 130 may mechanically couple enclosure 116 with display panel 110 and enclosure 126 with display panel 120 using a closed hinge angle of about zero degrees. FIG. 4B shows a side view of mobile display device 100 in paperback configuration 144 with a paperback hinge angle between about 60 degrees and about 180 degrees. Viewing surface 114 of enclosure 116 and viewing surface 124 of enclosure 126 may be simultaneously viewable by a user when positioned in paperback configuration 144. FIG. 4C shows a side view of mobile display device 100 in tablet configuration 146 with a tablet hinge angle of about 180 degrees. Viewing surface 114 of enclosure 116 and viewing surface 124 of enclosure 126 lie substantially in a common plane and may be simultaneously viewable by a user of mobile display device 100. FIG. 4D shows a side view of mobile display device 100 in back-to-back configuration 148 with a back-to-back hinge angle of about 360 degrees. Viewing surface 114 of enclosure 116 and viewing surface 124 of enclosure 126 face opposite directions when positioned in back-to-back configuration 148. Either viewing surface 114 or viewing surface 124 may be viewed by a user by flipping or rotating mobile display device 100 accordingly when positioned in back-to-back configuration 148. Alternatively, software running on mobile display device 100 may be configured so that a user may press, swipe or otherwise touch the backside display to activate a function or otherwise effectuate a change on the front-side display.

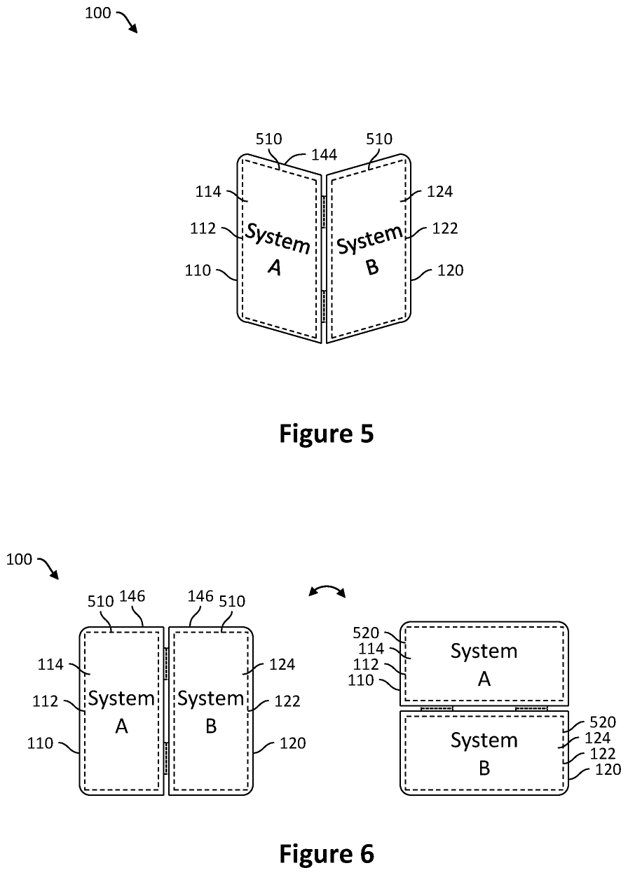

FIG. 5 illustrates mobile display device 100 in paperback configuration 144 with one display panel 110 operating in a first task mode and a second display panel 120 operating in a second task mode. Display panel 110 with display screen 112 and viewing surface 114 may have a full, stand-alone complement of hardware and software to control the operations of display panel 110. Display panel 120 with display screen 122 and viewing surface 124 may have a fully segregated, separate complement of hardware and software to control the operations of display panel 120. Display screens 112, 122 may be provided with display information in a portrait mode 510. Display information provided to each of display screens 112, 122 may depend on the particular task mode, with display information provided to display screen 112 generally different and independent of display information provided to display screen 122.

FIG. 6 illustrates mobile display device 100 in tablet configuration 146 with display panel 110 operating in a first task mode and display panel 120 operating in a second task mode. Each display may operate in a portrait mode 510, a landscape mode 520 or another mode such as a split mode or an inset mode.

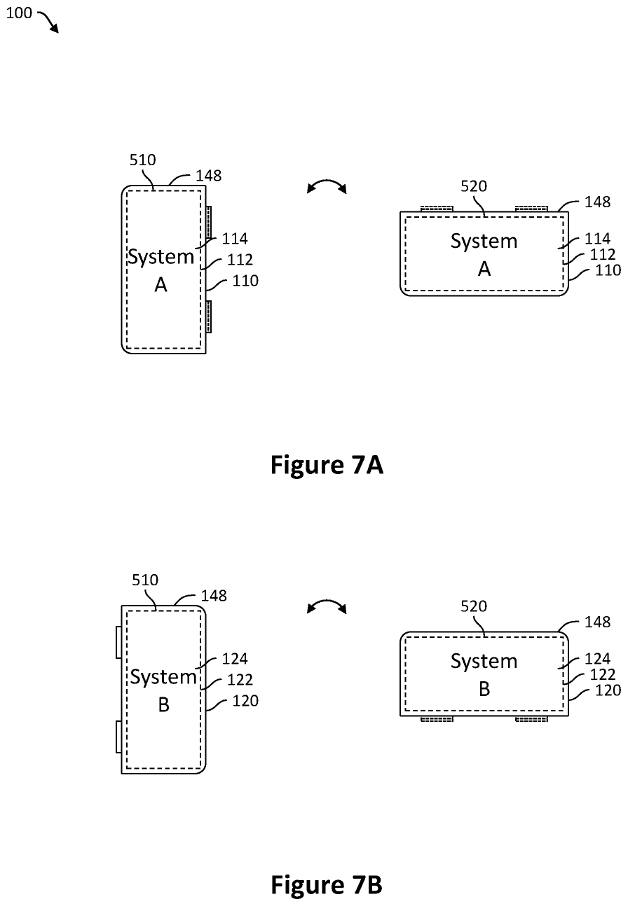

FIG. 7A and FIG. 7B illustrate mobile display device 100 in back-to-back configuration 148 with display panel 110 operating in a first task mode in either a portrait mode 510 or a landscape mode 520 and display panel 120 operating in a second task mode in either a portrait mode 510 or a landscape mode 520.

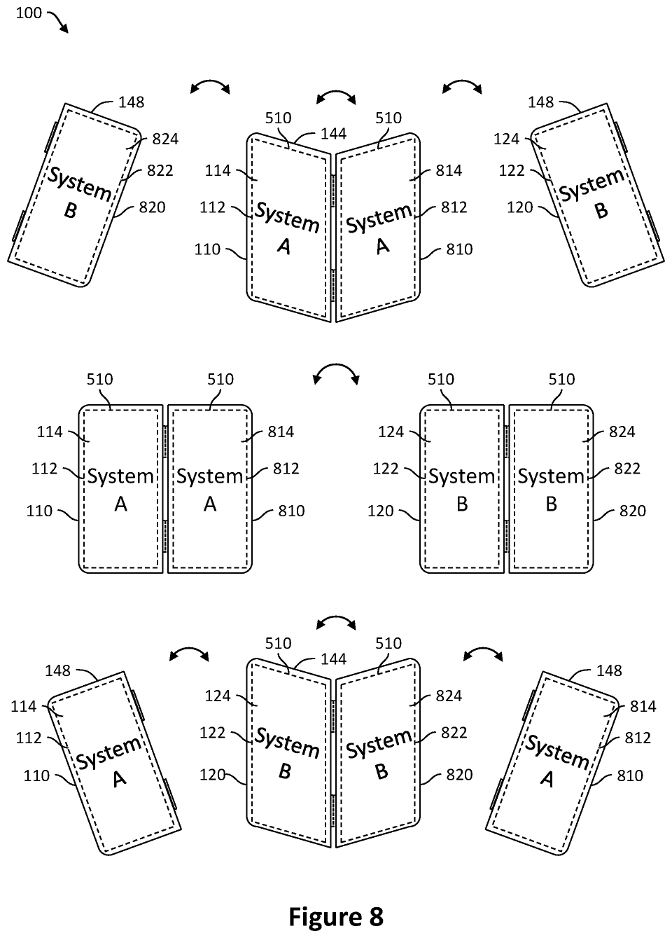

FIG. 8 illustrates various configurations of a mobile display device 100 having a quartet of display panels 110, 120, 810, 820. A set of hardware and software may be associated with two of the four display panels while another set of hardware and software may be associated with the remaining two display panels. For example, system A may be associated with display panels 110, 810 while system B may be associated with display panels 120, 820. Two display panels 110, 810 with display screens 112, 812 and viewing surfaces 114, 814 and associated hardware/software may be housed in a set of enclosures coupled with a multi-position hinge. A second group of display panels 120, 820 with display screens 122, 822 and viewing surfaces 124, 824 may be housed within the enclosures on opposite sides of display panels 110, 810. The various configurations shown include a closed configuration 142, a paperback configuration 144, a tablet configuration 146 and a back-to-back configuration 148. With four display screens 112, 122, 812, 822, display information may be provided to the exterior facing screens for viewing when mobile display device 100 is positioned in closed configuration 142 or back-to-back configuration 148. Similarly, when positioned in either paperback configuration 144 or tablet configuration 146, display information may be provided to any or all of display screens 112, 122, 812, 822 in either a portrait mode 510, a landscape mode 520, or other display mode.

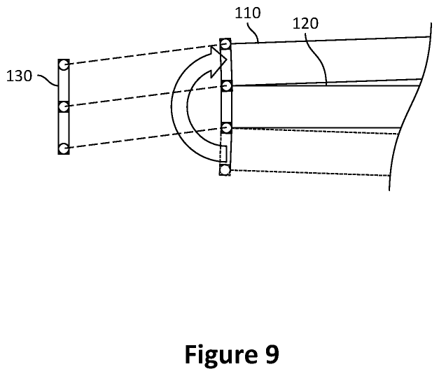

FIG. 9 illustrates a side view of multi-position hinge 130 coupling two display panels 110, 120. A portion of multi-position hinge 130 may be coupled to an enclosure housing display panel 110 and another portion of multi-position hinge 130 may be coupled to a second enclosure housing display panel 120. Multi-position hinge 130 mechanically couples display panel 110 and display panel 120, allowing rotation of the two display panels nearly a full turn as mobile display device 100 is reconfigured from a closed configuration to a back-to-back configuration. Mechanical coupling may he provided through one or more joints that allow rotational freedom while retaining positional contact between the two display panels. The joints may be augmented with resistive features or articulated surfaces that retain the enclosures in a preferred configuration while allowing mobile device 100 to be closed or placed in another preferred configuration during use. Electrical coupling may be provided through one or more wires, sliding electrical contacts, flexible printed circuit cables or the like that pass through one or more portions of multi-position hinge 130, allowing electrical connectivity while retaining mechanical rotation capability.

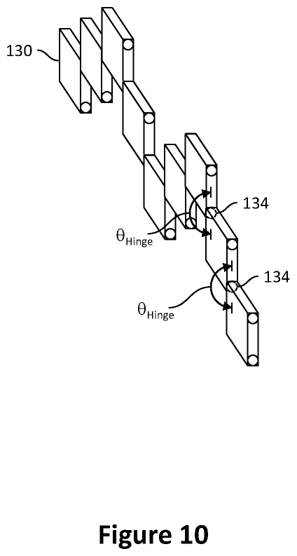

FIG. 10 shows a perspective view of one implementation of multi-position hinge 130 for a mobile display device having multiple display panels. Multi-position hinge 130 allows mechanical and electrical connections between two enclosures housing the display panels. One or more hinge-angle detectors 134 such as a rotational angle sensor or a magnetic proximity sensor may be coupled to multi-position hinge 130. Hinge-angle detectors 134 may provide one or more hinge-angle signals that may be used to determine the hinge angle between segments of multi-position hinge 130. The hinge angle may be used to determine whether the mobile display device is configured in a closed, paperback, tablet or back-to-back configuration so that display information may be provided to the display screens accordingly. Alternatively or in addition to, one or more orientation sensors within the mobile display device may be configured to detect a current orientation of the mobile display device and to provide display information to the display screens based on one or more orientation sensor signals from the orientation sensors.

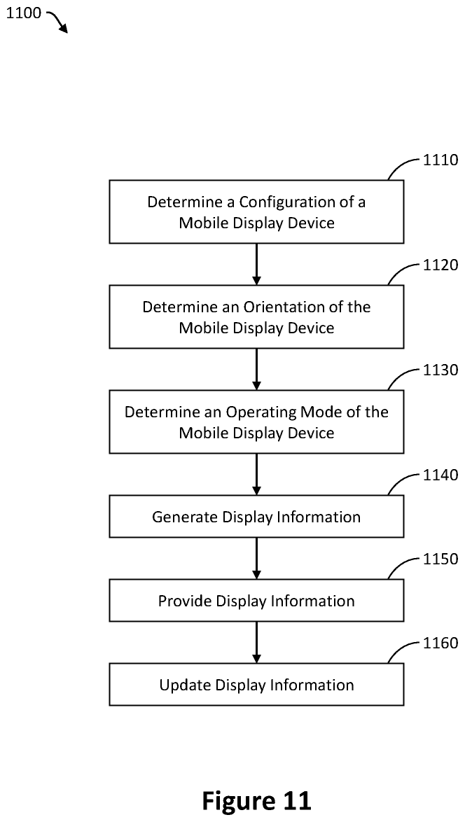

FIG. 11 shows a block diagram illustrating a method 1100 of operating a mobile display device having multiple display panels. The method may include determining a configuration of the mobile display device having a display panel enclosed within a first enclosure and a second display panel enclosed within a second enclosure, as shown in block 1110. The enclosures may be mechanically coupled with a multi-position hinge. Configurations of the mobile display device include a closed configuration, a paperback configuration, a tablet configuration, or a back-to-back configuration. Method 1100 may include determining an orientation of the mobile display device as shown in block 1120, such as which display panel is facing a user or what configuration the mobile display device is currently positioned in. Various orientations of the mobile display device may include a portrait orientation, a landscape orientation, a first task orientation, or a second task orientation. Method 1100 may include determining an operating mode of the mobile display device, such as whether the mobile display device is to be operated in a first task mode, a second task mode, or both a first task mode and a second task mode, as shown in block 1130. The task modes may correspond to a work usage mode and a personal usage mode. Method 1100 may include generating display information, as shown in block 1140. Method 1100 may include providing the generated display information to the first display panel, the second display panel, or both the first and second display panels, as shown in block 1150. In some implementations, one or more display panels may include a touchscreen. A software application or a software-generated window running in the mobile display device may be configured to allow a touch of a user on one touchscreen to activate a function on another display panel. The display information may be based on the configuration, the orientation, and the task mode. Display information for the first display panel may be provided by an operating system enclosed within the first enclosure, and display information for the second display panel may be provided by a second operating system enclosed within the second enclosure. Method 1100 may include updating the display information to the first display panel and the second display panel when the task mode is changed, as shown in block 1160. The first operating system may be configured to send a wireless signal to the second operating system to effect a change on the second display panel when a software application or a software-generated window running on the first operating system detects a touch of a user on the first display panel.

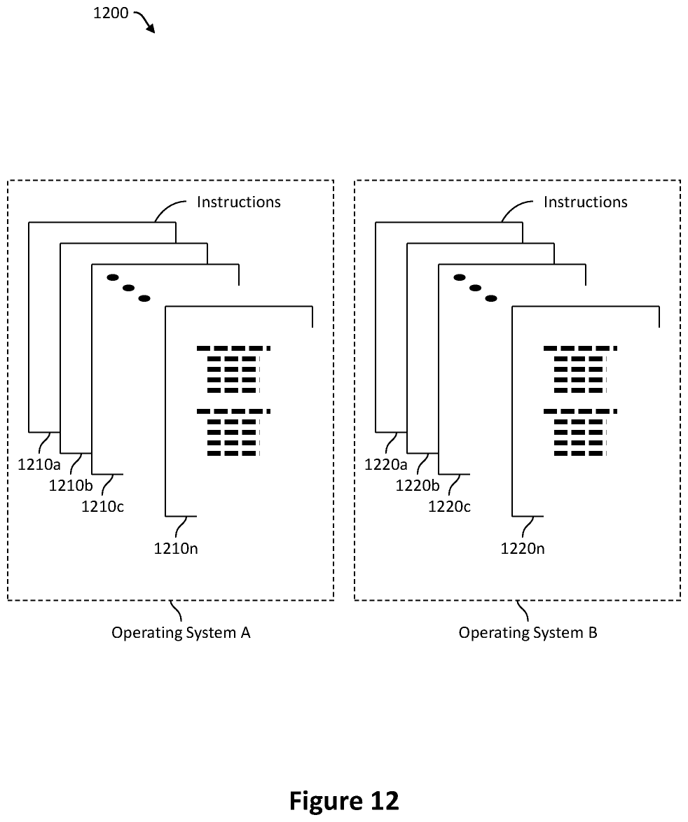

FIG. 12 illustrates computer-readable medium 1200 for operating a mobile display device having multiple display panels and segregated operating systems A, B. Computer-readable medium 1200 may include computer-readable instructions or blocks of instructions 1210a, 1210b, 1210c, . . . 1210n containing one or more lines of computer code for operating system A to allow determining a configuration of the mobile display device; determining an orientation of the mobile display device; determining whether the mobile display device is to be operated in a first task mode, a second task mode, or both a first task mode and a second task mode; and providing display information to the first display panel based on the configuration, the orientation, and the task mode. Computer-readable medium 1200 may include a segregated set of computer-readable instructions or blocks of instructions 1220a, 1220b, 1220c, . . . 1220n containing one or more lines of code for operating system B to allow determining a configuration of the mobile display device; determining an orientation of the mobile display device; determining whether the mobile display device is to be operated in a first task mode, a second task mode, or both a first task mode and a second task mode; and providing display information to the second display panel based on the configuration, the orientation, and the task mode. The computer-readable medium may include instructions to allow updating the display information to the first display panel and the second display panel when the task mode is changed. Computer-readable medium 1200 may include code for detecting an orientation of the mobile display device and/or a hinge angle of a multi-position hinge, generating display information for one or more of the display panels, and providing display information to the display panels. The display information may be based on the orientation of the mobile display device and the hinge angle when the mobile display device is positioned in a closed configuration, a paperback configuration, a tablet configuration, or a back-to-back configuration. When operating in a back-to-back configuration, the computer code may be configured to allow a software application or a software-generated window running in the mobile display device to detect a touch of a user on the backside display and to activate a function or otherwise effectuate a change on the front-side display panel.

While various implementations have been described above, it should be understood that the implementations have been presented by way of example and not limitation. The breadth and scope of the present disclosure should not be limited by any of the implementations described above but should be defined in accordance with the following claims, subsequently submitted claims, and their equivalents.

What is claimed is:

1. A mobile display device, the mobile display device comprising:
a first display panel including a first display screen having a viewing surface;
a second display panel coupled to the first display panel with a multi-position hinge, the second display panel including a second display screen having a viewing surface;
a first operating system coupled to the first display panel; and
a second operating system coupled to the second display panel;
wherein the first operating system is configurable to operate independently of the second operating system and wherein the second operating system is configurable to operate independently of the first operating system.

2. The mobile display device of claim 1, wherein the first operating system provides display information to the first display screen and wherein the second operating system provides display information to the second display screen.

3. The mobile display device of claim 1, wherein the first operating system is configurable to not provide display information to the second display screen and wherein the second operating system is configurable to not provide display information to the first display screen.

4. The mobile display device of claim 1, wherein display information from the first operating system is provided to the first display screen and wherein display information from the second operating system is provided to the second display screen when the first display panel and the second display panel are configured in one of a closed configuration, a paperback configuration, a tablet configuration, or a back-to-back configuration.

5. The mobile display device of claim 1, wherein the first display panel is enclosed within a first enclosure and the second display panel is enclosed within a second enclosure.

6. The mobile display device of claim 5, wherein the first enclosure and the second enclosure are mechanically coupled through the multi-position hinge.

7. The mobile display device of claim 5, further comprising:
a first battery module electrically coupled to the first operating system and a second battery module electrically coupled to the second operating system, wherein the first battery module is enclosed within the first enclosure and the second battery module is enclosed within the second enclosure.

8. The mobile display device of claim 5, further comprising:
a first communication module coupled to the first operating system and a second communication module coupled to the second operating system; wherein the first communication module is enclosed within the first enclosure and the second communication module is enclosed within the second enclosure; and wherein the first communication module is configurable to send a wireless signal to the second communication module to effect a change on the second display panel when a software application or a software-generated window running on the first operating system detects a touch of a user on the first display panel.

9. The mobile display device of claim 5, further comprising:
a first sensor module coupled to the first operating system and a second sensor module coupled to the second operating system, wherein the first sensor module is enclosed within the first enclosure and the second sensor module is enclosed within the second enclosure.

10. The mobile display device of claim 9, wherein the first sensor module and the second sensor module include at least one of an orientation sensor, a motion detector, an ambient light sensor, an eye-gazing detection system, a user identification system, an in-display fingerprint sensor, a through-display fingerprint sensor, or a finger detection sensor.

11. A method of operating a mobile display device, the method comprising:
determining a configuration of the mobile display device having a first display panel enclosed within a first enclosure and a second display panel enclosed within a second enclosure, the first enclosure and the second enclosure mechanically coupled with a multi-position hinge;
determining an orientation of the mobile display device;
determining whether the mobile display device is to be operated in one of a first task mode, a second task mode, or both a first task mode and a second task mode; and
providing display information to one of the first display panel, the second display panel, or both the first display panel and the second display panel based on the configuration, the orientation, and the task mode.

12. The method of claim 11, wherein the configuration of the mobile display device is one of a closed configuration, a paperback configuration, a tablet configuration, or a back-to-back configuration; wherein the second display panel includes a touchscreen; and wherein a software application or a software-generated window running in the mobile display device is configurable to allow a touch of a user on the touchscreen to activate a function on the first display panel.

13. The method of claim 11, wherein the orientation of the mobile display device is one of a portrait orientation, a landscape orientation, a first task orientation, or a second task orientation.

14. The method of claim 11, wherein the first task mode corresponds to a work usage mode and the second task mode corresponds to a personal usage mode.

15. The method of claim 11, wherein the display information to the first display panel is provided by a first operating system enclosed within the first enclosure, and wherein the display information to the second display panel is provided by a second operating system enclosed within the second enclosure.

16. The method of claim 11, further comprising:
updating the display information to the first display panel and the second display panel when the task mode is changed, wherein the first operating system is configurable to send a wireless signal to the second operating system to effect a change on the second display panel when a software application or a software-generated window running on the first operating system detects a touch of a user on the first display panel.

17. A system for operating a mobile display device, the system comprising:
a first display panel enclosed within a first enclosure and a second display panel enclosed within a second enclosure, the first enclosure and the second enclosure mechanically coupled with a multi-position hinge;
a first operating system contained within the first enclosure and coupled to the first display panel; and
a second operating system contained within the second enclosure and coupled to the second display panel;
wherein the first operating system and the second operating system are configurable to allow:
determining a configuration of the mobile display device;
determining an orientation of the mobile display device;
determining whether the mobile display device is to be operated in one of a first task mode, a second task mode, or both a first task mode and a second task mode; and
providing display information to one of the first display panel, the second display panel, or both the first display panel and the second display panel based on the configuration, the orientation, and the task mode.

18. The system of claim 17, wherein the first operating system and the second operating system are configurable to allow:
updating the display information to the first display panel and the second display panel when the task mode is changed, wherein the first operating system is configurable to send a wireless signal to the second operating system to effect a change on the second display panel when a software application or a software-generated window running on the first operating system detects a touch of a user on the first display panel.

19. Computer-readable medium for operating a mobile display device having a first display panel and a second display panel, the computer-readable medium including computer-readable instructions for:
determining a configuration of the mobile display device with a first operating system or a second operating system;
determining an orientation of the mobile display device with the first operating system or the second operating system;
determining whether the mobile display device is to be operated in one of a first task mode, a second task mode, or both a first task mode and a second task mode; and
providing display information to the first display panel from the first operating system or providing display information to the second display panel from the second operating system based on the configuration, the orientation, and the task mode;
wherein the first display panel is enclosed within a first enclosure and the second display panel is enclosed within a second enclosure, the first enclosure and the second enclosure mechanically coupled with a multi-position hinge.

20. The computer-readable medium of claim 19 further configured to allow:
updating the display information to the first display panel or the second display panel when the task mode is changed, wherein the first operating system is configurable to send a wireless signal to the second operating system to effect a change on the second display panel when a software application or a software-generated window running on the first operating system detects a touch of a user on the first display panel.
